(19) United States
(12) Patent Application Publication
(10) Pub. No.: US 2008/0284306 A1
(43) Pub. Date: Nov. 20, 2008

(54) Low-Pressure Mercury Vapor Discharge Lamp and Compact Fluorescent Lamp

(75) Inventors: Volker Dirk Hildenbrand, Eindhoven (NL); Gary Sigai, Salina, KS (US); Peter J. Schmidt, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/092,743

(22) PCT Filed: Nov. 6, 2006
(86) PCT No.: PCT/IB2006/054116

§ 371 Date: May 6, 2008

(30) Foreign Application Priority Data
Nov. 10, 2005 (EP) 05110592.2

(51) Int. Cl. H01J 1/62

(52) U.S. Cl. 313/487; 313/639

(57) ABSTRACT

A low-pressure mercury vapor discharge lamp has a light-transmitting discharge vessel (10) enclosing, in a gastight manner, a discharge space (13) provided with a filling of mercury and a rare gas. The discharge vessel comprises discharge means for maintaining a discharge in the discharge space. The discharge vessel is provided with a luminescent layer (17) comprising a mixture of at least a red and a green luminescent material. The red luminescent material comprises (Y,Gd)₂O₃:Eu. The green luminescent material comprises (Ba,Ca,Sr)₂SiO₄:Eu and/or (Sr,Ca,Ba,Mg,Zn)Si₂N₂O₂:Eu. Particles of the green luminescent material are surrounded by a coating of aluminum oxide. Preferably, at least 50% of the particles of the green and red luminescent materials have an average diameter greater than or equal to approximately 5 μm. The mixture of the red and green luminescent materials render a low-pressure mercury-vapor discharge lamp with an improved lumen equivalent.

### FIELD OF THE INVENTION

The invention relates to a low-pressure mercury vapor discharge lamp comprising a light-emitting discharge vessel provided with a luminescent layer.

The invention also relates to a compact fluorescent lamp.

### BACKGROUND OF THE INVENTION

In mercury vapor discharge lamps, mercury constitutes the primary component for the (efficient) generation of ultraviolet (UV) light. A luminescent layer comprising a luminescent material may be present on an inner wall of the discharge vessel to convert UV to other wavelengths, for example, to UV-B and UV-A for tanning purposes (sun tanning lamps) or to visible radiation for general illumination purposes. Such discharge lamps are therefore also referred to as fluorescent lamps. Fluorescent lamps for general illumination purposes usually comprise a mixture of three luminescent materials, for example, a blue-luminescent europium-activated barium magnesium aluminate, BaMgAl₁₀O₁₇:Eu²⁺(also referred to as BAM), a green-luminescent cerium-terbium co-activated lanthanum phosphate, LaPO₄:Ce,Tb (also referred to as LAP) and a red luminescent europium-activated yttrium oxide, Y₂O₃:Eu (also referred to as YOX).

The discharge vessel of low-pressure mercury vapor discharge lamps is usually circular and comprises both elongated and compact embodiments. Generally, the tubular discharge vessel of compact fluorescent lamps comprises a collection of relatively short straight parts having a relatively small diameter, which straight parts are connected together by means of bridge parts or via bent parts. Compact fluorescent lamps are usually provided with an (integrated) lamp cap. Normally, the means for maintaining a discharge in the discharge space are electrodes arranged in the discharge space. Alternatively, the low-pressure mercury vapor discharge lamp comprises a so-called electrodeless low-pressure mercury vapor discharge lamp.

A low-pressure mercury vapor discharge lamp of the type described in the opening paragraph is known from International Application WO-A 00/67 295. The known discharge lamp comprises a discharge vessel having a tubular portion provided with a metal oxide layer and a luminescent layer on a surface facing the discharge space. The tubular portion of the discharge vessel preferably has a further metal oxide layer which acts as an alkali metal-repellent layer. In an embodiment, the metal-oxide comprises nano-crystalline aluminum oxide particles, also known as Alon-C, with crystallite size of between approximately 20 nm and 40 nm. In another embodiment, the metal-oxide layer comprises larger particles with particle sizes between approximately 100 nm and 1000 nm, which serve as a reflector for light generated in the discharge and the luminescent layer, respectively. Instead of aluminum oxide also other oxides like yttrium oxide, zirconium oxide or mixtures of yttrium oxide with alkaline earth borates can be used. The known low-pressure mercury-vapor discharge lamp has comparatively low mercury consumption.

A drawback of the use of the known low-pressure mercury vapor discharge lamp is that the luminous efficiency has not increased in the last years while those of high-intensity discharge (HID) lamps and light-emitting diode (LED) lamps have. This development has led to a reduced gap between HID and LED lamps on one side and fluorescent lamps on the other.

### SUMMARY OF THE INVENTION

The invention has for its object to eliminate the above disadvantage wholly or partly. According to the invention, a low-pressure mercury vapor discharge lamp of the kind mentioned in the opening paragraph for this purpose comprises:
a light-emitting discharge vessel enclosing, in a gastight manner, a discharge space provided with a filling of mercury and a rare gas,
the discharge vessel comprising discharge means for maintaining a discharge in the discharge space,
the discharge vessel being provided with a luminescent layer, the luminescent layer comprising a mixture of at least a red and a green luminescent material,
the red luminescent material comprising (Y,Gd)₂O₃:Eu,
the green luminescent material comprising (Ba,Ca,Sr)₂SiO₄:Eu and/or (Sr,Ca,Ba,Mg,Zn)Si₂N₂O₂ Eu,
particles of the green luminescent material being surrounded by a coating of aluminum oxide.

Surprisingly, this mixture of the red luminescent material comprising (Y,Gd)₂O₃:Eu and the aluminum oxide-coated green luminescent material comprising (Ba,Ca,Sr)₂SiO₄:Eu and/or (Sr,Ca,Ba,Mg,Zn)Si₂N₂O₂:Eu, yields a low-pressure mercury-vapor discharge lamp with improved luminous efficiency as compared to the known luminescent materials employed in the known low-pressure mercury-vapor discharge lamp.

The lumen equivalent, also denoted as LE, of a luminescent material (phosphor) is a measure for how efficient the phosphor emission P(λ) in Watt is in generating luminous flux in lumen. It is defined as:

$$L E = 683 \frac{lm}{W} \frac{{\int }_{380 nm}^{780 nm} P ( λ ) \times \overline{y} ( λ ) d λ}{{\int }_{380 nm}^{780 nm} P ( λ ) d λ}$$

wherein y(λ) is the tri-stimulus value or visibility function value. Typical values for the commonly used luminescent materials in low-pressure mercury vapor lamps are:

70 lm/W for BaMgAl₁₀O₁₇:Eu (blue phosphor),

495 lm/W for LaPO₄:Ce,Tb (green phosphor), and

285 lm/W for Y₂O₃:Eu (red phosphor).

In known mixtures of luminescent materials for correlated color temperatures between 2700 and 6500 K, the main components are green and red. Generally speaking, the volume fraction of the blue component varies between approximately 1% and approximately 25%, that of the green component between approximately 20% and approximately 50% and that of the red component between approximately 20% and approximately 70%. In mixtures with a highly-correlated color temperature, the contribution of the green luminescent component is highest. The overall contribution of one of the components to the luminous efficiency of the system is determined by the volume fraction multiplied by the lumen equivalent, assuming that the quantum efficiencies of the luminescent materials used are, generally, close to or above 0.9. Since the self-absorption of resonant radiation in the known low-pressure mercury-vapor discharge lamps is relatively small, that is between 0% and approximately 30%, the effect of absorption of reflected light is of relatively minor importance, because the average absorption of the phosphor components is in the order of larger than 80%.

The green luminescent material (Sr,Ca,Ba,Mg,Zn)Si₂N₂O₂:Eu has a relatively high lumen equivalent (larger than that of the known LaPO₄:Ce,Tb (LAP), CeMgAl₁₁O₁₉:Tb (CAT) or GdMgB₅O₁₀:Ce,Tb (CBT)). A drawback of the use of an oxonitridosilicate is that it is relatively difficult to synthesize resulting in a relatively high cost price. An alternative for (Sr,Ca,Ba,Mg,Zn)Si₂N₂O₂:Eu is the Eu-doped Ba-Sr-Ca-orthosilicate with general formula (Ba,Sr,Ca)₂SiO₄:Eu. The latter luminescent material is a low-cost substitute for the oxonitridosilicate. The Eu-doped Ba-Sr-Ca-orthosilicate can be prepared relatively easily from relatively inexpensive raw materials. However, the stability in humid environments and in particular in mercury discharge lamps is relatively bad. As far as known to the inventors, Eu-doped Ba-Sr-Ca-orthosilicates have never been employed in low-pressure mercury-vapor discharge lamps.

By providing a protective coating of aluminum oxide on the particles of the green luminescent materials, (Ba,Ca,Sr)₂SiO₄:Eu or (Sr,Ca,Ba,Mg,Zn)Si₂N₂O₂:Eu, the stability of the luminescent materials is largely improved. Provision of a protective coating on the particle of the red luminescent material comprising (Y,Gd)₂O₃:Eu is not deemed necessary.

The mixture of the red luminescent material comprising (Y,Gd)₂O₃:Eu and the aluminum oxide-coated green luminescent material (Ba,Ca,Sr)₂SiO₄:Eu, results in a low-pressure mercury-vapor discharge lamp with a lumen equivalent of the aluminum oxide-coated green luminescent material (Ba,Ca,Sr)₂SiO₄:Eu of as high as 505 lm/W.

The mixture of the red luminescent material comprising (Y,Gd)₂O₃:Eu and the aluminum oxide-coated green luminescent material comprising (Ba,Ca,Sr)₂SiO₄:Eu and/or (Sr,Ca,Ba,Mg,Zn)Si₂N₂O₂:Eu, yields a low-pressure mercury-vapor discharge lamp with an improved lumen equivalent as compared to the known luminescent materials employed in the known low-pressure mercury-vapor discharge lamp.

A preferred embodiment of the low-pressure mercury vapor discharge lamp according to the invention is characterized in that the particles of the green luminescent material and particles of the red luminescent material have an average diameter greater than or equal to approximately 2 μm. The absorption of the red luminescent material can be increased if the particle size is increased. However, the particle size should not be too large to avoid problems with the stability of suspensions used to coat the tubes of the fluorescent lamps.

Another preferred embodiment of the low-pressure mercury vapor discharge lamp according to the invention is characterized in that at least 50% of the particles of the green and red luminescent materials have an average diameter greater than or equal to approximately 5 μm. For example, the red luminescent material comprising (Y,Gd)₂O₃:Eu with a particle size of approximately 5 micrometers has an absorption between approximately 0.85 and approximately 0.92 at 254 nm. The absorption can be increased if the particle size is increased. However, the particle size should not be too large to avoid problems with the stability of the suspensions employed to coat the tubes of the fluorescent lamps.

The effectiveness of the protective coating on the particles of the green luminescent material can be improved. To this end, a preferred embodiment of the low-pressure mercury vapor discharge lamp according to the invention is characterized in that the particles of the green luminescent material are provided with a coating of silica surrounded by the coating of aluminum oxide.

Fluorescent lamps for general illumination purposes usually comprise a mixture of three luminescent materials, i.e. a blue-luminescent, a green-luminescent and a red luminescent material. To this end, a preferred embodiment of the low-pressure mercury vapor discharge lamp according to the invention is characterized in that the luminescent layer further comprises a blue luminescent material. Preferably, the blue luminescent material comprises BaMgAl₁₀O₁₇:Eu or (Sr,Ca,Mg)₅(PO₄)₃Cl:Eu.

Preferably, the means for maintaining the discharge in the discharge space comprise electrodes arranged in the discharge space.

The invention also relates to a compact fluorescent lamp wherein a lamp housing is attached to the discharge vessel of the low-pressure mercury-vapor discharge lamp, which lamp housing is provided with a lamp cap.

### BRIEF DESCRIPTION OF THE DRAWINGS

These and other aspects of the invention will be apparent from and elucidated with reference to the embodiments described hereinafter.

In the drawings:

FIG. 1A is an embodiment of the low-pressure mercury vapor discharge lamp according to the invention in a longitudinal section, and

FIG. 1B is a detail of the discharge lamp of FIG. 1, taken on the line II in FIG. 1.

The Figures are purely diagrammatic and not drawn to scale. Particularly for clarity, some dimensions are strongly exaggerated. Similar components in the Figures are as much as possible denoted by the same reference numerals.

### DETAILED DESCRIPTION OF THE PREFERRED EMBODIMENTS

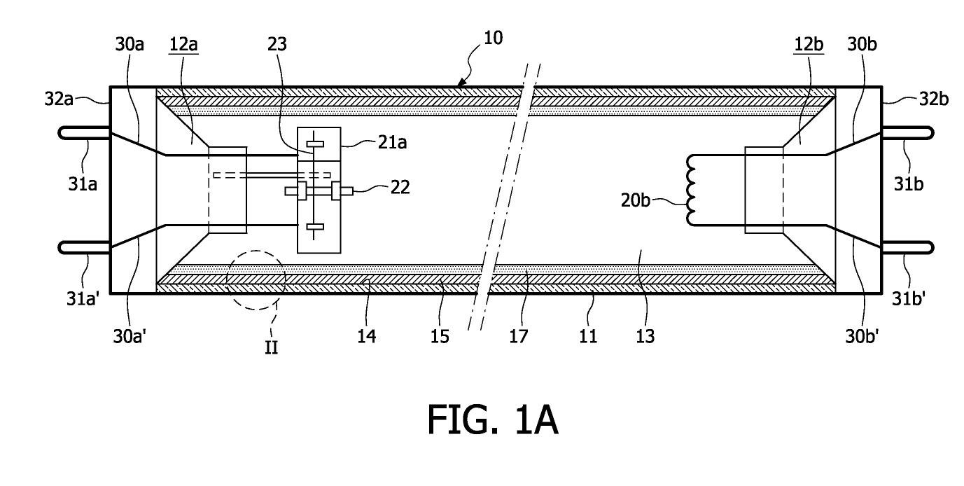

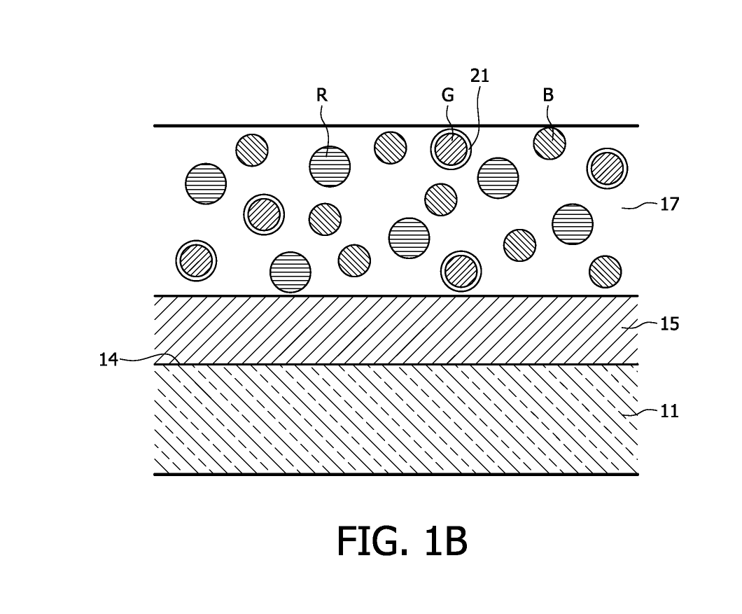

FIG. 1A schematically shows a low-pressure mercury vapor discharge lamp comprising a glass discharge vessel 10 having a tubular portion 11 which is transmissive to radiation generated in the discharge vessel 10, and a first and a second end portion 12a, 12b. The tubular portion 11 has a length of approximately 120 cm and an external diameter of 2.5 cm for a so-called T8 fluorescent lamp and an external diameter of 1.6 cm for a so-called T5 fluorescent lamp. The discharge vessel 10 encloses a discharge space 13 comprising a filling of several mg of mercury and a rare gas, in this example argon, in a gastight manner. The end portions 12a; 12b each support an electrode 20b (the electrode on the first end portion 12a is not shown in FIG. 1A) arranged in the discharge space 13. The electrodes 20b constitute the discharge means of this embodiment of the low-pressure mercury-vapor discharge lamp. Current supply conductors 30a, 30a′; 30b, 30b′ of the electrodes 20b extend through the end portions 12a; 12b to the exterior of the discharge vessel 10. The current supply conductors 30a, 30a′; 30b, 30b′ are connected to contact pins 31a, 31a′; 31b, 31b′ secured to a lamp base 32a; 32b. An electrode ring 21a is arranged around each electrode 20b (the electrode ring on the second end portion 12b is not shown in FIG. 1A).

A glass capsule 22 is clamped to the electrode ring 21a, with which capsule mercury is dosed during manufacture of the discharge lamp. To this end, a metal wire 23 which was tightened to the glass capsule 22, was inductively heated in a high-frequency electromagnetic field, during which the capsule 22 was cut through and the mercury to be dosed from the capsule 22 was released to the discharge space 13.

In the example of FIG. 1A and FIG. 1B a protective layer 15 (see also FIG. 1B) is provided on the surface 14 of the tubular portion 11 facing the discharge space. The protective layer 15 comprises, for example a nano-crystalline aluminum oxide (Al₂O₃) or an yttrium oxide (Y₂O₃) layer having a coating weight of approximately 30 μg/cm². Higher coating weights are required for aluminum oxide layers with particle sizes between approximately 100 nm and about 1 μm. Typical coating weights for these materials are between approximately 0.2 and 1.5 mg/cm². In addition, the protective layer 15 is provided with a luminescent layer 17 with a coating weight greater than 1.0 mg/cm comprising (Y,Gd)₂O₃:Eu as red luminescent material, (Ba,Ca,Sr)₂SiO₄:Eu and/or (Sr,Ca,Ba,Mg,Zn)Si₂N₂O₂ as green luminescent material:Eu and BaMgAl₁₀O₁₇:Eu or (Sr,Ca,Mg)₅(PO₄)₃Cl:Eu as blue luminescent material. Particles G of the green luminescent material are surrounded by a coating 21 of aluminum oxide. Preferably, the particles G of the green luminescent material are provided with a one-layer coating of aluminum oxide. Preferably, the particles G of the green luminescent material are provided with a two-layer coating of silica and aluminum oxide, the silica coating surrounding the coating of aluminum oxide.

Preferably, the particles G of the green luminescent material and particles R of the red luminescent material have an average diameter greater than or equal to approximately 2 μm. On the one hand, the absorption of the red luminescent material is increased if the particle size is increased. On the other hand, to avoid problems with the stability of suspensions used to coat the tubes of the fluorescent lamps, the particle size should not be too large. Preferably, at least 50% of the particles G, R of the green and red luminescent materials have an average diameter greater than or equal to approximately 5 μm. For example, the red luminescent material comprising (Y,Gd)₂O₃:Eu with a particle size of approximately 5 micrometer has an absorption between approximately 0.75 and approximately 0.85 at 254 nm.

For the green luminescent material (Sr,Ca,Ba,Mg,Zn)Si₂N₂O₂:Eu, the following stochiometries can be selected:

(Sr_{1-b-c-d-e}Ca_{b}Ba_{c}Mg_{d}Znₑ)SiₓN_{y}O_{z}:Euₐ,

wherein

0.002≦a≦0.2,

0.0≦b≦0.25,

0.0≦c≦0.25,

0.0≦d≦0.25,

0.0≦e≦0.25,

1.5≦x≦2.5,

1.5≦y≦2.5, and

1.5≦z≦2.5.

A favorable example of such green luminescent materials is the oxonitridosilicate SrSi₂N₂O₂:Eu with a lumen equivalent of approximately 527 lm/W compared with 495 lm/W for the standard green phosphor LaPO₄:Ce,Tb. Another favorable example of such green luminescent materials is the oxonitridosilicate with a stoichiometry found of SrSi_{2.24}N_{2.11}O_{2.26}Eu_{0.020} with a lumen equivalent of approximately 524 lm/W.

The combination of the Eu²⁺-doped oxonitridosilicate with e.g. Eu-doped BaMgAl₁₀O₁₇ or (Y,Gd)₂O₃:Eu results in a phosphor mixture with a higher lumen equivalent and higher efficiency as compared to the standard luminescent materials. If the quantum efficiencies are comparable and the absorption is not below 80%, the lumen equivalent of the component times the volume fraction of the phosphor determines the lumen equivalent of the total mixture. Since the lumen equivalent of the Eu-doped SrSi₂N₂O₂ is approximately 5 to 6% higher than that of the standard LaPO₄:Ce,Tb and the volume percentage of the green component is in the order of 20-50% a luminous efficiency increase of 1-3% is expected.

During the manufacture of a low-pressure mercury-vapor discharge lamp according to the invention, coated particles G of the green luminescent material comprising (Ba,Ca,Sr)₂SiO₄:Eu or (Sr,Ca,Ba,Mg,Zn)Si₂N₂O₂:Eu, are mixed with particles R of the red luminescent material (Y,Gd)₂O₃:Eu and with particles B of the standard blue luminescent material BaMgAl₁₀O₁₇:Eu in the appropriate ratio in order to generate common color temperatures for general lighting between 2700K and 6500K, in extreme cases up to 14,000K. The phosphor coating is deposited on a glass tubing e.g. a T8 or a T5 tube using water- or solvent-based suspensions. A common solvent is butylacetate in which nitrocellulose is used as binder to adjust the viscosity and the layer thickness, respectively. In water, polyacrylic acids can be used as stabilizers and e.g. polyethers or polyacids with a high molecular weight are used as binders. The suspensions are subsequently poured into the tubes and dried with an air flow. The binder is removed with a short heating step in air or oxygen. The sintering of the fluorescent layer during the manufacture of the discharge vessel takes place at temperatures in the range from approximately 500° C. to approximately 600° C.

An alternative embodiment of the discharge lamp in accordance with the invention comprises so-called electrodeless discharge lamps, in which the means for maintaining an electric discharge are situated outside a discharge space surrounded by the discharge vessel. Generally said means are formed by a coil provided with a winding of an electric conductor, with a high-frequency voltage, for example having a frequency of approximately 3 MHz, being supplied to said coil, in operation. In general, said coil surrounds a core of a soft-magnetic material.

An alternative embodiment of the discharge lamp in accordance with the invention comprises a so-called compact fluorescent lamp. Such a compact fluorescent lamp comprises a lamp housing attached to the discharge vessel of the low-pressure mercury-vapor discharge lamp, which lamp housing is provided with a lamp cap.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A low-pressure mercury vapor discharge lamp comprising:
a light-emitting discharge vessel (10) enclosing, in a gastight manner, a discharge space (13) provided with a filling of mercury and a rare gas,
the discharge vessel (10) comprising discharge means for maintaining a discharge in the discharge space (13),
the discharge vessel (10) being provided with a luminescent layer (17), the luminescent layer (17) comprising a mixture of at least a red and a green luminescent material,
the red luminescent material comprising (Y,Gd)₂O₃:Eu,
the green luminescent material comprising (Ba,Ca,Sr)₂SiO₄:Eu and/or (Sr,Ca,Ba,Mg,Zn)Si₂N₂O₂ Eu,
particles (G) of the green luminescent material being surrounded by a coating (21) of aluminum oxide.

2. A low-pressure mercury vapor discharge lamp as claimed in claim 1, wherein the particles (G) of the green luminescent material and particles (R) of the red luminescent material have an average diameter greater than or equal to approximately 2 μm.

3. A low-pressure mercury vapor discharge lamp as claimed in claim 1, wherein at least 50% of the particles (G, R) of the green and red luminescent materials have an average diameter greater than or equal to approximately 5 μm.

4. A low-pressure mercury vapor discharge lamp as claimed in claim 1, wherein the particles (G) of the green luminescent material are provided with a coating of silica surrounded by the coating of aluminum oxide.

5. A low-pressure mercury vapor discharge lamp as claimed in claim 1, wherein the luminescent layer further comprises a blue luminescent material.

6. A low-pressure mercury vapor discharge lamp as claimed in claim 5, wherein the blue luminescent material comprises BaMgAl₁₀O₁₇ or (Sr,Ca,Mg)₅(PO₄)₃Cl:Eu.

7. A low-pressure mercury vapor discharge lamp as claimed in claim 1, wherein the means for maintaining the discharge in the discharge space (13) comprise electrodes (20b) arranged in the discharge space (13).

8. A compact fluorescent lamp comprising a low-pressure mercury-vapor discharge lamp as claimed in claim 1, characterized in that a lamp housing is attached to the discharge vessel of the low-pressure mercury-vapor discharge lamp, which lamp housing is provided with a lamp cap.
